(19) United States
(12) Patent Application Publication
(10) Pub. No.: US 2010/0162902 A1
(43) Pub. Date: Jul. 1, 2010

(54) DEVICE FOR INSTALLING FLAT SKEWERS INTO INGREDIENTS FOR MAKING BROCHETTES

(75) Inventor: Denis Paya, Perigneux (FR)

Correspondence Address: HESLIN ROTHENBERG FARLEY & MESITI PC, 5 COLUMBIA CIRCLE, ALBANY, NY, 12203, US

(73) Assignee: EMSENS ANTOINE, Fraisses (FR)

(21) Appl. No.: 12/529,847

(22) PCT Filed: Mar. 3, 2008
(86) PCT No.: PCT/FR2008/050357

§ 371 Date: Feb. 8, 2010

(30) Foreign Application Priority Data
Mar. 6, 2007 (FR) 0753673

(51) Int. Cl. A47J 37/04

(52) U.S. Cl. 99/419

(57) ABSTRACT

A device for inserting flat skewers into ingredients for making brochettes, the ingredients are disposed in a recess or impression provided in at least one plate. The device includes an inlet guide having a groove intended to receive a skewer and co-operating with a guide that can re-centre the skewer as it is moved by a push rod inserted into the groove. A second groove is provided in the plate opposite to and coaxially aligned with the first groove. The second groove opens into the recess that receives the ingredients. The second groove co-operates with a guide that can direct and hold the skewer as the ingredients are being skewered under the force of the push rod.

The invention relates to the technical field of machines for processing foodstuffs and more particularly machines for making kebabs of meat and/or vegetables, or the like, manually, semi-automatically, or automatically.

Different technical solutions have been proposed for making kebabs industrially. In particular, machines are known that can automatically skewer different layers of meat and vegetables placed in a tray, configured in such a way that the different layers for skewering can also be cut up, to form the kebabs as such. The different layers of meat and vegetables are skewered using wooden stakes of general cylindrical shape which are driven simultaneously into the different layers, by means of fittings such as skewering tubes.

A proposal has also been put forward for making kebabs automatically or semi-automatically, no longer on the basis of pre-cut slices, but on the basis of different pieces of meat, vegetables, fruit etc. A solution of this type is clear in the teaching of patent FR 2.725.591 which is also held by the applicant hereto.

In the main, said machine comprises plates that have impressions capable of receiving the ingredients required to build up the kebab. Said plates may for example be joined to each other to form an endless chain or carousel conveyor. The plates can be brought one after the other opposite a skewering station configured in such a way that a stake can be inserted into the different ingredients placed in the impression. Each impression, of substantially rectangular general shape, defines a volume capable of being stocked with the different required ingredients: pieces of meat, vegetable, fruit, etc. The size of the impression, and possibly the geometrical shape thereof, are dependent on the type of kebab it is wished to obtain.

Here again, in order to make kebabs in this way that are similar to those that can be made manually, the stakes used are generally wooden stakes of general cylindrical shape.

In fact, for some types of kebabs, the stakes are no longer constituted by wooden sticks of general cylindrical shape, but by sticks of plane cross-section. For example, said sticks are of general rectangular shape with rounded ends, or of the flag type with a gripper part of substantially rectangular general shape extended by a filiform part. These sticks or stakes are more often than not used to make mini-kebabs. The plane cross-section of the stakes facilitates marking for advertising purposes or the like. With this type of stake, the different ingredients which are to form the kebab are skewered in an entirely manual way.

From this prior art, the problem the invention proposes to resolve is that of enabling the automatic or semi-automatic skewering of different pieces of meat, vegetable, fruit and the like, in order to make kebabs, no longer based on cylindrical stakes, but based on stakes of plane cross-section and more generally stakes that have at least two parallel faces.

To resolve said problem, a device has been designed and perfected for skewering stakes of plane cross-section into ingredients in order to make kebabs, the ingredients being placed in an impression provided on at least one plate.

According to the invention, the device comprises an input guide with a groove for receiving a stake and engaging with guidance means capable of realigning the stake as it moves under the effect of a push rod running in the groove; opposite to and in coaxial alignment with the groove is placed another groove provided on the plate and leading to the impression receiving the ingredients, the groove in the plate engaging with guidance means capable of directing and holding the stake when the ingredients are skewered as a result of the action of the push rod.

To advantage, in order to resolve the problem posed by industrial skewering, the plate providing the impression is joined to other identical plates, to form a linear or cylinder conveyor, said plates being brought one after the other step by step opposite the input guide in the groove alignment position.

To resolve the problem posed by automatically placing the stakes in the input guide, the input guide is mounted in combination with a magazine unit configured to receive a plurality of stakes stacked one on top of the other, in correspondence with the groove in said guide.

In one embodiment, the magazine unit is constituted by columns between which the stakes are placed flat, pressing against the push rod, so that following withdrawal of the push rod, the stake pressing against it falls under the effect of gravity into the groove of the input guide.

To resolve the problem posed by directing and holding the stake as much as possible so that the skewering can be done as straight as possible, the guidance means form baffles for gradually reducing the width of the grooves as a function of the flat profile of the stakes as they are driven in.

Still with the objective of being able to guide the stake perfectly at the time of skewering, one or more support elements is/are placed over the groove or grooves of the input guide and/or of the plate receiving the ingredients.

According to other characteristics, the thickness of the stakes and the thickness of the push rod running in the grooves of the input guide and the plate are substantially the same.

The magazine can be recharged manually or automatically.

As indicated, the technical characteristics of the invention allow the different ingredients of the kebabs to be skewered using stakes of plate cross-section. To this end, the stakes may be sticks, of general rectangular shape with rounded ends, or flags with a gripper part of substantially rectangular general shape, extended by a filiform part.

The stakes may be made out of wood, bamboo, metal, plastic, steel, etc.

The invention is disclosed in further detail hereinafter using the figures from the appended drawings wherein:

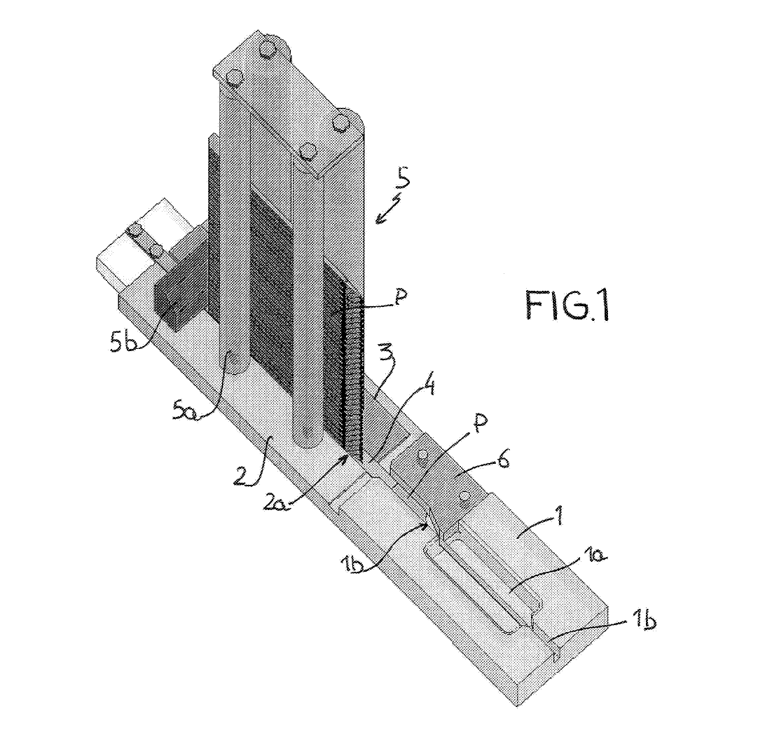

FIG. 1 is a perspective view showing the underlying principle of the inventive skewering device, the device being shown in the position in which the stake is driven into the impression (the ingredients are not shown);

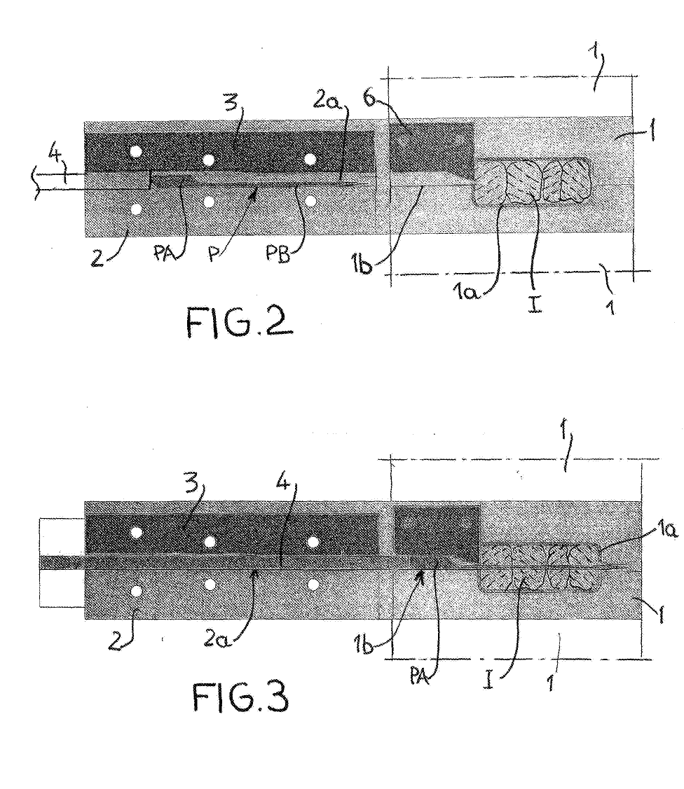

FIG. 2 is a diagrammatic plan view prior to the skewering of the ingredients placed in the impression of a plate which is part of a conveyor;

FIG. 3 is a view corresponding to FIG. 2 showing the ingredients being skewered.

As indicated, the objective sought in accordance with the invention is to allow different ingredients (I) in the form of pieces of meat, vegetable, fruit and the like to be skewered using stakes (P) of plane cross-section. Said stakes (P) are fully known to the man skilled in the art and are, for example, sticks, of general rectangular shape with rounded ends, or, as shown in the figures in the drawings, these stakes (P) are of the flag type with a gripper part (PA), of substantially rectangular general shape, extended by a filiform part (PB). More generally, the invention relates to skewering by means of any type of stake that has at least two parallel plane faces. The stakes (P) can be made out of any material: wood, bamboo, metal, plastic, etc.

The different ingredients (I) are placed in an impression (1a) provided in at least one plate (1). In a known way, each impression (1a) has a general rectangular shape whereof the dimensions correspond very substantially to the dimensions of the kebab it is wished to obtain. The impression (1a) communicates, at each of its ends, with a groove (1b) formed in the thickness of the plate, in coaxial alignment with the median part of the impression.

According to the invention, the skewering device or station, comprises an input guide (2) that has, substantially in the median part thereof, a groove (2a) for receiving a stake (P). One of the edges at least of the groove (2a) engages with guidance means (3) capable of realigning the stake as it moves under the effect of a push rod (4) running in said groove (2a). The push rod (4) is subject to any actuation means, of the jack type or the like.

The grooves (1b) and (2a) are placed in coaxial alignment.

The input guide (2) is mounted in combination with a magazine unit (5) configured to receive a plurality of stakes (P) stacked one on top of the other, in correspondence with the groove (2a). For example, the magazine unit (5) consists of columns (5a) between which the stakes (P) are placed flat and a back-end stop column (5b). After the stakes (P) are stacked, the stake placed in the lower part presses against the push rod (4), such that, as will be shown in the remainder of the description, following withdrawal of the push rod, the stake pressing against it falls under the effect of gravity into the groove (2a) of the input guide (2), in furtherance of the skewering operation as such.

To skewer in this way, the grooves (1b) and (2a) are, as shown, placed in coaxial alignment. To this end, in a simplified version, the plate (1) and the input guide (2) constitute a single unit cast in one piece.

In a preferred way, the plates (1) are configured so as to be joined to each other, in order to form a linear or cylinder conveyor, while being subject to any means in order to bring each of the plates one after the other, step by step, opposite the input guide (2) in the position where the grooves (1a) and (2a) are aligned.

To advantage, the plate (1), or each of the plates (1), also has, particularly upstream of the impression (1a) considered in the direction of skewering, guidance means (6) capable of directing and holding the stake when the ingredients are skewered. Said guidance means (3) and (6) which are in communication with one of the sides at least of the grooves (2a) and (1a), constitute baffles for reducing the width of the grooves (2a) and (1a), gradually, as a function of the flat profile of the stakes (P) as they are driven in. The number and form of the guidance means depends on the type of stakes used. These guidance means may be made out of a material different from that constituting the input guide (2) and the plates (1).

The device operates as follows.

As indicated the different stakes (P) are stored flat, stacked one on top of the other, between the columns (5a) of the magazine (5) (FIG. 11). This magazine may be recharged manually or automatically.

When the push rod (4) is withdrawn, the bottom stake is placed in the groove (2a) of the input guide (2). When the push rod (4) is activated, because of the baffles and the gradients for reducing the guidance means (3), the stake (P) is channelled and positioned before being skewered (FIG. 2). The push rod (4) continues to push the stake in the groove (2a), in order to direct it into the groove (1a) of the plate (1), so that the different ingredients (I) placed in the impression (1a) (FIG. 3) can be skewered. Here again, as the stake (P) is driven into the different ingredients, it is perfectly channelled by the guidance means (6). It should be noted that the thickness of the stakes and the thickness of the push rod are substantially the same.

In the skewered position, in other words after the stake (P) is driven into the ingredients (I), the column of stakes for skewering, rests on the push rod (4). In these conditions, when the push rod (4) reaches the back position (FIG. 2), the store of stakes held between the columns (5a) is released, the bottom stake positioning itself automatically under the effect of gravity in the bottom of the groove (2a) of the input guide (2).

It should be noted that still with the objective of perfectly channelling and guiding the stake during the skewering phase, one or more of the support elements (not shown) may be placed over the groove or grooves (2a) of the input guide (2) and/or (1a) of the plate (1).

It should be noted that in the context of a plurality of plates (1) placed one after the other step by step opposite the skewering guide (2), in the conditions indicated, after the ingredients are skewered, the plates may engage with any system allowing the kebab so formed to be ejected.

The advantages are quite clear from the description.

1. Device for introducing skewering stakes of planar cross-section into ingredients to make kebabs, comprising an impression for receiving the ingredients provided on at least one plate, an input guide with a first groove receiving a stake of planar cross section and engaging with first guidance means for realigning the stake as the stake moves under the effect of a push rod running in the first groove; a second groove opposite to and in coaxial alignment with the first groove, the second groove being provided on the plate and leading to the impression receiving the ingredients, the second groove engaging with second guidance means for directing and holding the stake when the ingredients are skewered as a result of action of the push rod.

2. Device as claimed in claim 1, wherein the plate with the impression is joined to other identical plates, so as to form a linear or cylindrical conveyor, said plates being brought one after the other, step by step, opposite the input guide in a position where the first and second grooves are aligned.

3. Device as claimed in claim 1, wherein the input guide is mounted in combination with a magazine unit configured to receive a plurality of stakes of planar cross-sections stacked one on top of an other, in correspondence with the first groove of said guide.

4. Device as claimed in claim 3, wherein the magazine unit comprises columns between which the stakes are placed flat, with a bottom stake pressing against the push rod such that following withdrawal of the push rod, the bottom stake pressing against the push rod falls under effect of gravity into the first groove of the input guide.

5. Device as claimed in claim 1, wherein the first and second guidance means constitute baffles for gradually reducing width of the first and second grooves as a function of a flat profile of the stakes as stakes are driven into the ingredients.

6. Device as claimed in claim 1, wherein the thickness of each of the stakes and thickness of the push rod running in the grooves of the input guide and of the plate are substantially the same.

7. Device as claimed in claim 3, wherein the magazine unit is recharged manually or automatically.

8. Device as claimed in claim 1, wherein one or more support elements is/are placed above the first groove of the input guide and/or the second groove of the plate.

9. Device as claimed in claim 1, wherein the stakes of planar cross-section comprise sticks, of general rectangular shape with rounded ends.

10. Device as claimed in claim 1, wherein the stakes of planar cross-section have a flag configuration, with a gripper part of substantially rectangular general shape extended by a filiform part.
